(19) United States
(12) Patent Application Publication
(10) Pub. No.: US 2017/0272545 A1
(43) Pub. Date: Sep. 21, 2017

(54) METHOD AND SYSTEM FOR TRANSMITTING REMOTE SCREEN

(71) Applicant: Electronics and Telecommunications Research Institute, Daejeon (KR)

(72) Inventors: Eun Jung KWON, Daejeon (KR); Jung Hak KIM, Daejeon (KR); Hyun Ho PARK, Daejeon (KR); Sung Won BYON, Seongnam-si (KR); Yong Tae LEE, Daejeon (KR); Eui Suk JUNG, Daejeon (KR); Hyun Woo LEE, Seoul (KR)

(73) Assignee: Electronics and Telecommunications Research Institute, Daejeon (KR)

(21) Appl. No.: 15/456,977

(22) Filed: Mar. 13, 2017

(30) Foreign Application Priority Data
Mar. 16, 2016 (KR) 10-2016-0031267

(51) Int. Cl. H04L 29/06

(52) U.S. Cl. CPC H04L 67/38; H04L 67/42; H04L 69/04

(57) ABSTRACT

Provided is a remote screen transmitting method and a remote screen transmitting system. The remote screen transmitting method may include collecting, on a predetermined cycle, power data from a thin client terminal connected to a virtualization server through a network, determining a remote screen transmitting scheme based on the collected power data, and transmitting, to the thin client terminal, a first remote screen associated with an application executed on the virtualization server based on the remote screen transmitting scheme.

### CROSS-REFERENCE TO RELATED APPLICATION(S)

This application claims the priority benefit of Korean Patent Application No. 10-2016-0031267 filed on Mar. 16, 2016, in the Korean Intellectual Property Office, the disclosure of which is incorporated herein by reference for all purposes.

### BACKGROUND

1. Field

One or more example embodiments relate to technology for effectively controlling a power in a thin client terminal, and more particularly, to a remote screen transmitting method and system for reducing an amount of power consumed by the thin client terminal in lieu of decreasing a quality of user experience by transmitting a screen, for example, a remote screen, of an execution result of an application executed on a virtualization server by applying a remote screen transmitting scheme based an amount of power consumed by the thin client terminal.

2. Description of Related Art

A thin client terminal refers to a personal computer (PC) terminal through which all work is done on a terminal server (virtualization server) including an essential hardware device that is connected through a network.

The terminal server may use a virtual desktop infrastructure (VDI) as virtualization technology that classifies each user session as a virtual machine (VM) for executing dozens of individual user sessions.

The thin client terminal is easier to manage, requires less space and costs less than a desktop computer with software, such that the number of places having a thin client PC working environment is increasing.

Because the use of thin client terminals is increasing, remote screen transmitting technology for transmitting an execution screen of an application executed on a virtualization server to the thin client terminal while providing a quality of user experience, may be required.

Because performance of a thin client terminal may be limited or decreased due to insufficient expandability, high delay rate and low bandwidth, various virtualization solutions that enhance user experience by applying a remote transmission protocol that improves performance have been suggested.

To provide a quality of user experience similar to that of a remote screen displayed on the thin client terminal, a scheme for compressing a screen displayed by a virtualization server and transmitting the screen using a streaming technique may be used through server rendering. However, in this case, it may be difficult to effectively control power consumption in a mobile terminal that limitedly uses a battery, and a thin client terminal, for example, a home consumer electronic device and a set-top box, that consumes a great amount of power.

In addition, the central processing unit (CPU) in a thin client terminal works harder due to the complexity of the screen transmitting scheme to which a remote screen transmission protocol is applied for enhancing a quality of user experience. Thus, a thin client terminal may consume relatively more power.

However, technology for transmitting a remote screen based on the amount of power consumed by the thin client terminal, for example, a home consumer electronic device or mobile terminal that limitedly uses a battery, is still insufficient.

### SUMMARY

An aspect of the present invention provides a method and system for dynamically determining a remote screen transmitting scheme based on power data in a thin client terminal and transmitting a remote screen to the thin client terminal, thereby effectively controlling an amount of power consumed by the thin client terminal in lieu of deteriorating a quality of user experience.

Another aspect also provides the method and system for decreasing the amount of power consumed by the thin client terminal that limitedly uses a power to increase an amount of time a battery may be used by dynamically determining a remote screen transmitting scheme when an amount of power remaining in the thin client terminal is less than a preference value or the amount of power consumed by the thin client terminal is greater than or equal to a threshold during transmission of the remote screen to the thin client terminal.

Still another aspect also provides the method and system for executing (displaying) the remote screen as a result of an application being executed on a virtualization server on a cloud in a thin client terminal of low specification while maintaining a quality of user experience based on power consumption.

According to an aspect, there is provided a remote screen transmitting method including collecting, on a predetermined cycle, power data from a thin client terminal connected to a virtualization server through a network, determining a remote screen transmitting scheme based on the collected power data, and transmitting, to the thin client terminal, a first remote screen associated with an application executed on the virtualization server based on the remote screen transmitting scheme.

According to another aspect, there is provided a remote screen transmitting system including a collector configured to collect, on a predetermined cycle, power data from a thin client terminal connected to a virtualization server through a network, a determiner configured to determine a remote screen transmitting scheme based on the collected power data, and a transmitter configured to transmit, to the thin client terminal, a first remote screen associated with an application executed on the virtualization server based on the remote screen transmitting scheme.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating a connection relationship between a virtualization server and a wired and wireless thin client terminal according to an example embodiment;

FIG. 2 is a block diagram illustrating an internal configuration of a remote screen transmitting system according to an example embodiment;

FIG. 3 is a diagram illustrating a method of transmitting a remote screen associated with an application executed on a virtualization server to a thin client terminal in a remote screen transmitting system according to an example embodiment;

FIG. 4 is a diagram illustrating a method of transmitting a remote screen based on an amount of power consumed by a thin client terminal in a remote screen transmitting system according to an example embodiment;

FIG. 5 is a flowchart illustrating a remote screen transmitting process according to an example embodiment;

FIG. 6 is a diagram illustrating a method of controlling an amount of power consumed by a thin client terminal using a remote frame buffer (RFB) protocol in a remote screen transmitting system according to an example embodiment;

FIG. 7 is a flowchart illustrating a process of changing a compression scheme as a remote screen transmitting scheme based on power data collected from a thin client terminal in a remote screen transmitting system according to an example embodiment; and

FIG. 8 is a diagram illustrating an update request message received from a thin client terminal and an update message to be transmitted to the thin client terminal in response to the update request message according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

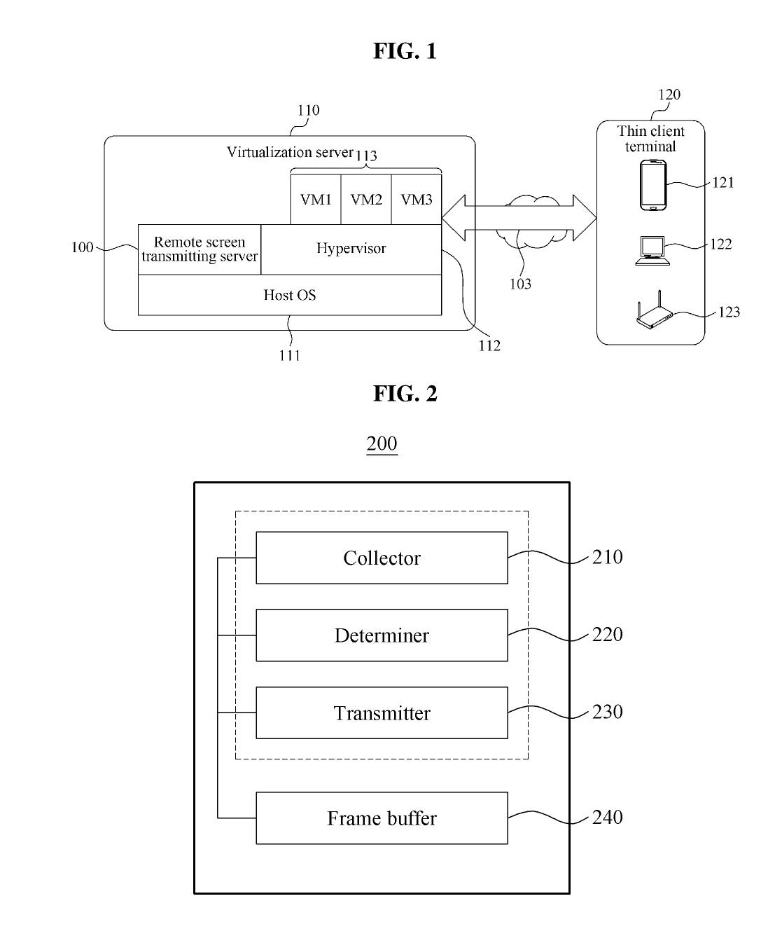

FIG. 1 is a diagram illustrating a connection relationship between a virtualization server and a wired and wireless thin client terminal according to an example embodiment.

Referring to FIG. 1, a remote screen transmitting system may be implemented by a remote screen transmitting server 100.

Between a virtualization server 110 and a thin client terminal 120, the remote screen transmitting server 100 may dynamically determine (convert) a remote screen transmitting scheme and transmit a remote screen to the thin client terminal 120 using the remote screen transmitting scheme, based on power data including an amount of power consumed by the thin client terminal 120 and an amount of power remaining in the thin client terminal 120 collected, on a predetermined cycle, from the thin client terminal 120. Where it is described that an amount of power consumed by a thin client terminal and an amount of power remaining in the thin client terminal are in data or a message, the terms amount of power consumed and amount of remaining power may refer to data or information.

The remote screen transmitting server 100 may transmit the remote screen including an update screen obtained by capturing an execution screen of an application executed on the virtualization server 110 to the thin client terminal 120 connected through a wired and wireless network, or receive an input event from the thin client terminal 120.

The thin client terminal 120 may be at least one of a mobile terminal 121, for example, a smartphone or a tablet personal computer (PC), a home consumer electronic device 122, for example, a television (TV) or a display device, or a home set-top box 123.

The virtualization server 110 may include the remote screen transmitting server 100, a host operation system (OS) 111, a hypervisor 112, and a virtual machine (VM) 113 including a VM1, a VM2, and a VM3.

The virtualization server 110 may have the host OS 111 based on Linux as a server platform, and generate the VM 113 using the hypervisor 112, for example, a Quick Emulator/Kernel-based Virtual Machine (QEMU/KVM) and XenServer.

The virtualization server 110 may transmit the remote screen obtained by capturing an execution screen of the VM 113 to remote screen transmitting client software executed in the thin client terminal 120 through the remote screen transmitting server 100 operating as a plug-in library of the hypervisor 112.

The remote screen transmitting server 100 may operate in the host OS 111 based on an operation of the hypervisor 112, and transmit the remote screen to the thin client terminal 120 through a remote screen transmission protocol, for example, a remote frame buffer (RFB), RDP, a PC-over_IP (PCoIP), and SPICE, or transmit a user input/output (I/O) value of the thin client terminal 120 to the virtualization server 110.

The remote screen transmitting server 100 may dynamically determine a remote screen transmitting scheme for transmitting the remote screen, for example, an image and a video stream, to the thin client terminal 120 based on an amount of power consumed by the thin client terminal 120.

Here, the remote screen transmitting scheme may be classified as a server rendering scheme, a client rendering scheme, or a hybrid scheme that combines the server rendering scheme and the client rendering scheme, based on a location (server or client) at which “rendering” is performed. The “rendering” may create a graphic image in the thin client terminal 120.

The client rendering scheme is a scheme in which graphic rendering is performed in the thin client terminal 120. In the client rendering scheme, a volume of data to be transmitted to the thin client terminal 120 is relatively small, but a performance level that makes it possible to process a rendering command may be required.

The server rendering scheme is a scheme that captures and transmits a result screen obtained by performing rendering in the virtualization server 110 using a central processing unit (CPU) and a graphic processing unit (GPU) to the thin client terminal 120. In the server rendering scheme, the volume of data to be transmitted to the thin client terminal 120 is relatively large, but a relatively low level of performance may be required to process a rendering command in the thin client terminal 120.

The hybrid scheme is a scheme that processes an operation available for rendering in the thin client terminal 120 based on a client rendering scheme and processes an operation unavailable for rendering in the thin client terminal 120 based on a server rendering scheme.

The remote screen transmitting server 100 may determine the remote screen transmitting scheme as any one of the client rendering scheme, the server rendering scheme, or the hybrid scheme based on at least one of whether a graphic image, that is, a remote screen, to be processed is a static screen or an active screen, a network data transmission rate, or a degree of delay affecting user experience. The remote screen transmitting server 100 may determine the remote screen transmitting scheme based on whether it is to transmit a portion of a server rendering screen or to capture and transmit the entire server rendering screen using a video streaming method through a compression encoding process.

The remote screen transmitting server 100, on a predetermined cycle, for example, a screen update cycle, may change a frame buffer compression scheme to decrease the amount of power consumed by the thin client terminal 120 when the amount of power consumed in the power data collected from the thin client terminal 120 is greater than or equal to a first threshold.

The remote screen transmitting server 100 may generate a frame buffer processing command to report the power data indicating the amount of power consumed and the amount of power remaining in the thin client terminal 120 to the virtualization server 110.

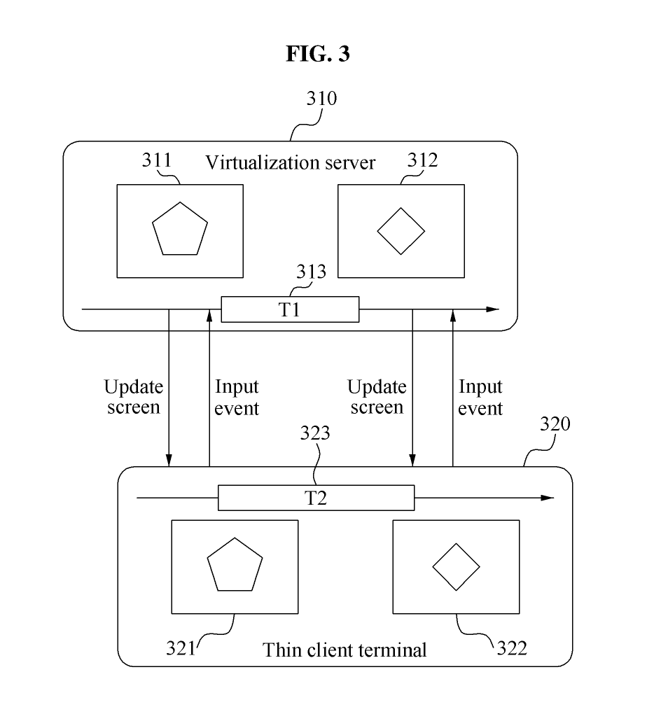

FIG. 2 is a block diagram illustrating an internal configuration of a remote screen transmitting system according to an example embodiment.

Referring to FIG. 2, a remote screen transmitting system 200 includes a collector 210, a determiner 220, a transmitter 230, and a frame buffer 240.

The collector 210 may collect, on a predetermined cycle, power data from a thin client terminal connected to a virtualization server through a network.

The thin client terminal is an apparatus to execute and display a remote screen obtained by capturing an execution screen of an application executed on a virtualization server. For example, the thin client terminal may be at least one of a mobile terminal, for example, a smartphone and a tablet personal computer (PC) that limitedly uses a battery, a home consumer electronic device, for example, a television (TV) and a display device, and a home set-top box that consumes a great amount of power.

For example, when a point during a selected screen update cycle arrives, the collector 210 may collect the power data including an amount of power consumed by the thin client terminal and an amount of power remaining in the thin client terminal.

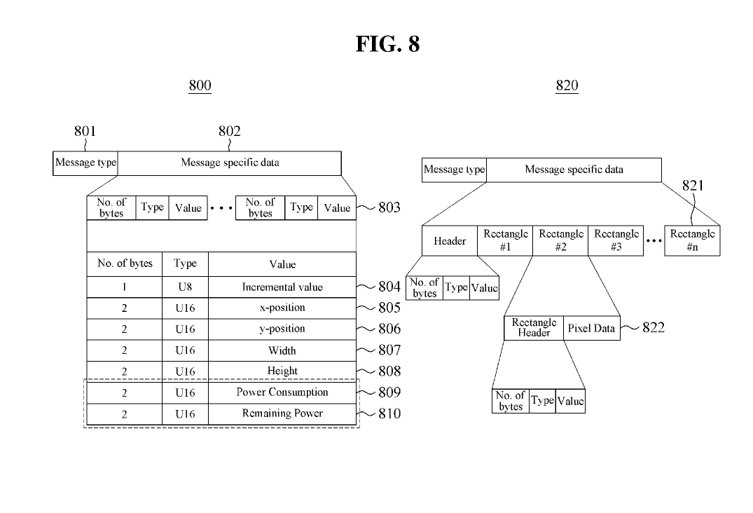

For example, referring to FIG. 8, the collector 210 may collect power data including an amount of power consumption 809 and an amount of remaining power 810 from an update request message 800 when the update request message 800 is transmitted to the virtualization server from the thin client terminal. Hereinafter, the amount of power consumption 809 is referred to as an amount of power consumed by a thin client terminal, and the amount of remaining power 810 is referred to as an amount of power remaining in the thin client terminal.

The determiner 220 may determine a remote screen transmitting scheme based on the collected power data including the amount of power consumed by the thin client terminal and the amount of power remaining in the thin client terminal.

The determiner 220 may determine the remote screen transmitting scheme including at least one of a frame processing rate during compressing, a compression scheme, or whether a first remote screen is compressed when transmitting the first remote screen to the thin client terminal based on the amount of power consumed by the thin client terminal and the amount of power remaining in the thin client terminal, in the collected power data.

The determiner 220 may determine the remote screen transmitting scheme to be a RAW data transmitting scheme not using the compression scheme when the amount of power remaining in the thin client terminal in the power data is less than a reference value or an amount of power consumed by the thin client terminal in the power data is greater than or equal to a set first threshold.

For example, the determiner 220 may decide not use the compression scheme when the first remote screen is transmitted to the thin client terminal by determining the remote screen transmitting scheme to be a RAW data transmitting scheme, such that an amount of use of a central processing unit (CPU) in the thin client terminal is decreased and the amount of power consumed is decreased, when it is determined that a power required for operating the thin client terminal is less than a minimum amount of power, for example, a reference value, or the amount of power currently consumed by the thin client terminal is greater than or equal to a first threshold even though the amount of remaining power is greater than or equal to the reference value.

Based on the amount of power consumed, the determiner 220 may change the compression scheme when the first remote screen is transmitted to the thin client terminal when the amount of power remaining in the thin client terminal in the power data is greater than or equal to the reference value and the amount of power consumed by the thin client terminal in the power data is less than the set first threshold.

The determiner 220 may change the compression scheme to a joint photographic coding experts group (JPEG) encoding scheme when the amount of power consumed is less than a second threshold less than the first threshold.

The determiner 220 may determine, again, whether the amount of power consumed is less than the second threshold less than the first threshold when it is determined again that the amount of power currently consumed by the thin client terminal is less than the first threshold and corresponds to a normal amount of power consumed.

When it is determined again that the amount of power consumed is less than the second threshold, the determiner 220 may determine that the thin client terminal currently consumes a low amount of power and may change the compression scheme to a high efficiency compression scheme, for example, the JPEG encoding scheme, in order to enhance a quality of user experience.

Also, the determiner 220 may selectively change the compression scheme to at least one of a Zlib run-length encoding (ZRLE) scheme, a Hextile encoding scheme, a CopyRect encoding scheme, provided by a remote frame buffer (RFB) protocol, when the amount of power consumed is less than the first threshold and greater than or equal to the second threshold.

When the amount of power consumed is greater than or equal to the second threshold and less than the first threshold, it is determined that the thin client terminal currently consumes a medium amount of power. Thus, the determiner 220 may selectively change the compression scheme to one of the compression schemes, for example, the ZRLE encoding scheme, the Hextile encoding scheme, and the CopyRect encoding scheme, provided by the RFP protocol.

Thus, the determiner 220 may effectively control the amount of power consumed by the thin client terminal in lieu of decreasing the quality of user experience by dynamically determining the remote screen transmitting scheme based on the amount of power consumed by the thin client terminal.

The transmitter 230 may transmit the first remote screen associated with the application executed on the virtualization server to the thin client terminal based on the remote screen transmitting scheme.

The transmitter 230 may store the first remote screen obtained by capturing the execution screen of the application executed on the virtualization server in the frame buffer 240. Here, the transmitter 230 may extract a changed portion, that is, an updated area, from the first remote screen, and store the updated area and the first remote screen in the frame buffer 240 based on the second remote screen corresponding to a previous version of the first remote screen.

The frame buffer 240 may be generated for each application executed on the virtualization server or generated for each version or each point in time with respect to an identical application whenever the execution screen of the application is captured.

The frame buffer 240 may be included in the remote screen transmitting system 200, or included inside the virtualization server, outside the remote screen transmitting system 200.

In an example, when the point during the selected screen update cycle arrives, the transmitter 230 may obtain the second remote screen from the frame buffer 240 assigned to the previous version differing from a current version of the first remote screen, and extract the updated area from the first remote screen based on the second remote screen, and transmit the updated area to the thin client terminal based on the remote screen transmitting scheme.

The transmitter 230 may minimize an amount of traffic used to transmit the updated area to the thin client terminal by comparing the first remote screen obtained by capturing the execution screen of the application executed on the virtualization server to the second remote screen corresponding to a previously captured screen obtained from the frame buffer 240 and transmit the updated area to the thin client terminal through a remote screen transmission protocol.

In the thin client terminal, the received updated area and the second remote screen corresponding to the previous version may be rendered, such that the first remote screen corresponding to the current version may be displayed.

Here, the transmitter 230 may encode the first remote screen in real time and transmit the first remote screen to the thin client terminal when an amount of change in the first remote screen is relatively great.

In another example, the transmitter 230 may store the updated area and the first remote screen in the frame buffer 240 assigned to the current version. When the second remote screen is maintained in the thin client terminal, the transmitter 230 may transmit, to the thin client terminal, a buffer value for the frame buffer 240 that stores the remote screen obtained by capturing the execution screen of the application executed on the virtualization server and allow the thin client terminal to use the updated area during rendering of the first remote screen by searching for the updated area in the frame buffer 240 identified by the thin client terminal based on the buffer value.

For example, referring to FIG. 8, the transmitter 230 may transmit an update message 820 including the buffer value for the frame buffer 240 in which the updated area is maintained in response to the update request message 800 from the thin client terminal, and allow the thin client terminal to render the updated area by searching for the updated area in the frame buffer 240 identified by the thin client terminal based on the buffer value. Thus, the identical first remote screen in the virtualization server may be displayed by the thin client terminal through rendering of a graphic image.

The transmitter 230 may determine an incremental value 804 in the update request message 800 when the update request message 800 is repeatedly received by the thin client terminal, with respect to the frame buffer in which an identical remote screen is maintained. When the incremental value 804 does not correspond to “0”, that is, when the thin client terminal has a previously received frame buffer value (the second remote screen corresponding to the previous version), the transmitter 230 may transmit the update message 820 including pixel data 822, as RAW data, for a rectangle field that constitutes the updated area in the first remote screen to the thin client terminal, in lieu of transmitting, to the thin client terminal, a total value of the frame buffer in which the first remote screen corresponding to the current version is maintained.

When the second remote screen is not maintained in the thin client terminal, the transmitter 230 may transmit, to the thin client terminal, the buffer value for the frame buffer 240 that stores the remote screen obtained by capturing the execution screen of the application executed on the virtualization server, and allow the thin client terminal to use the remote screen during rendering of the first remote screen by searching for the remote screen in the frame buffer 240 identified by the thin client terminal based on the buffer value.

The transmitter 230 may transmit the remote screen again by transmitting the buffer value for the frame buffer 240 in which the remote screen is maintained to the thin client terminal when the remote screen transmitted to the thin client terminal is not maintained in the thin client terminal. Thus, the thin client terminal may display the identical first remote screen in the virtualization server using the remote screen retrieved using the buffer value.

The transmitter 230 may reduce overhead of the virtualization server and decrease the amount of power consumed by the thin client terminal when the buffer value used to maintain the updated area is transmitted, in comparison to the updated area extracted from the first remote screen being transmitted to the thin client terminal.

Referring to FIG. 8, when the incremental value 804 corresponds to “0”, that is, when the thin client terminal does not have the previously received frame buffer value (the second remote screen corresponding to the previous version), the transmitter 230 may generate the update message 820 to be transmitted to the thin client terminal by encoding a total value of the frame buffer 240 in which the first remote screen corresponding to the current version is maintained.

When an image or a video stream is included in the first remote screen, the transmitter 230 may adjust a frame processing rate for compression of the first remote screen based on a pattern of the amount of power consumed by the thin client terminal in the power data, and transmit the first remote screen to the thin client terminal based on the adjusted frame processing rate.

Based on the amount of power consumed by the thin client terminal in the power data, the transmitter 230 may determine the frame processing rate for compression of the remote screen and transmit the remote screen to the thin client terminal based on the determined frame processing rate.

Also, the transmitter 230 may transmit the first remote screen to the thin client terminal by determining the remote screen transmitting scheme requested by the thin client terminal when the first remote screen is transmitted to the thin client terminal based on the RFB protocol.

In an example, in a process in which the virtualization server is initially connected to the thin client terminal, the collector 210 may obtain information on a compression scheme preferred by the thin client terminal. The determiner 220 may determine the compression scheme preferred by the thin client terminal as the remote screen transmitting scheme, and transmit the first remote screen to the thin client terminal based on the remote screen transmitting scheme.

Also, when a plurality of update request messages associated with the frame buffer 240 are received from the thin client terminal, the transmitter 230 may assign a buffer value transmission priority to each of the update request messages based on an amount of remaining power in each of the update request messages.

For example, referring to FIG. 8, when the update request message 800 is repeatedly received from the identical thin client terminal, the transmitter 230 may transmit, to the thin client terminal, the update message 820 for the update request message 800 in which the amount of remaining power 810 is lowest by including the buffer value, in lieu of transmitting all update messages, for example, the update message 820, in response to each update request message 800. Thus, the transmitter 230 may selectively respond to a most recent update request from the thin client terminal, thereby effectively decreasing the amount of power consumed by the thin client terminal.

When more than one of the thin client terminal is provided, the processor 230 may assign the buffer value transmission priority to each of the thin client terminals based on the amount of power remaining in each of the thin client terminals in the power data collected from the thin client terminals.

For example, referring to FIG. 8, the transmitter 230 may assign high priority to a thin client terminal of which the amount of remaining power 810 in the update request message 800 is relatively low among the thin client terminals that transmit the update request message 800 to the virtualization server using a scheduler, and transmit the update message 820 in response to the update request message 800 from the thin client terminal assigned high priority.

In an example, the transmitter 230 may actively switch the virtualization mode to a standby mode to reduce a standby power of the virtualization server when the thin client terminal is in the standby mode or an update request message is not received from the thin client terminal for a predetermined length of time.

In detail, the transmitter 230 may allow the virtualization server to stop using a resource, for example, a graphic processing unit (GPU) resource, a memory resource, and network resource, of a process corresponding to the thin client terminal in the virtualization server while the thin client terminal is in the standby mode, such that the virtualization server is switched to the standby mode.

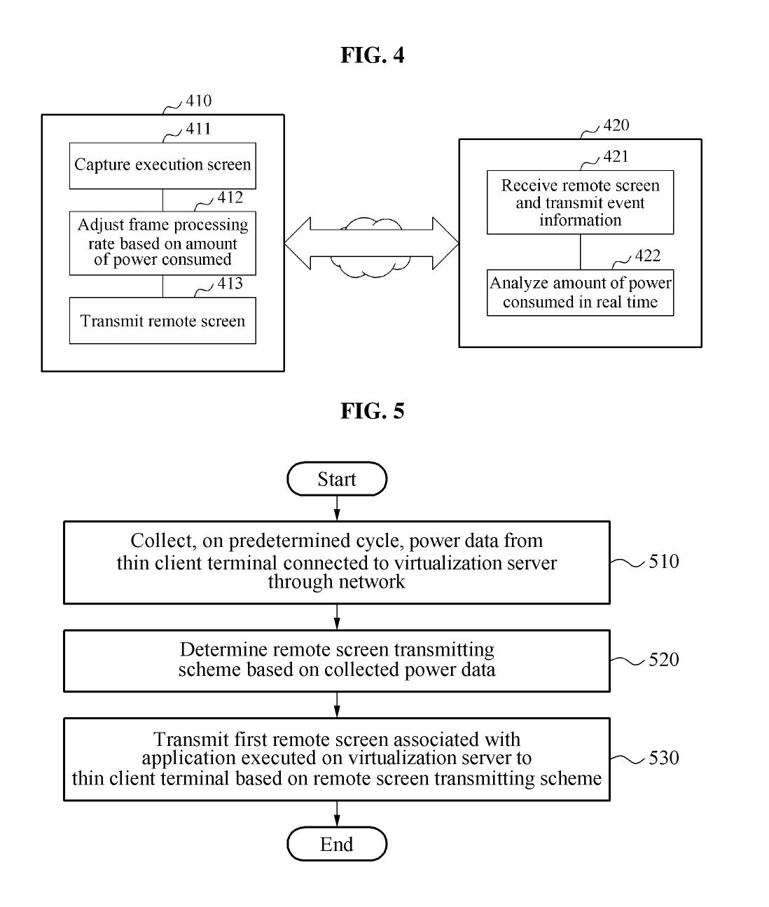

FIG. 3 is a diagram illustrating a method of transmitting a remote screen associated with an application executed on a virtualization server to a thin client terminal in a remote screen transmitting system according to an example embodiment.

Referring to FIG. 3, a remote screen transmitting system may be included in a virtualization server 310.

When a point during a screen update cycle arrives, the remote screen transmitting system may compare a first remote screen 311 obtained by capturing an execution screen of an application executed on the virtualization server 310 to a second remote screen 312 corresponding to a previously captured image obtained from a frame buffer, and then transmit an updated area to a thin client terminal 320 through a remote screen transmission protocol 313, thereby minimizing an amount of traffic used to transmit the updated area to the thin client terminal 320.

When an amount of change in the first remote screen 311 is great, the remote screen transmitting system may encode the first remote screen 311 in real time and transmit the encoded first remote screen 311 to the thin client terminal 320.

When the updated area is received through a remote screen reception protocol 323, the thin client terminal 320 may execute a first remote screen 321 by rendering the received updated area and a second remote screen 322 executed (displayed) in the thin client terminal 320.

When the point during the screen update cycle arrives, the thin client terminal 320 may transmit power data to the remote screen transmitting system, and the remote screen transmitting system may determine a frame processing rate based on a pattern of an amount of power consumed by the thin client terminal in the received power data and transmit the first remote screen 311 to the thin client terminal 320.

FIG. 4 is a diagram illustrating a method of transmitting a remote screen based on an amount of power consumed by a thin client terminal in a remote screen transmitting system according to an example embodiment.

Referring to FIG. 4, a remote screen transmitting system may be included in a virtualization server 410.

The remote screen transmitting system may collect power data transmitted to the virtualization server 410 by a thin client terminal 420, on a predetermined cycle, for example, a screen update cycle, or when an event occurs.

In operation 411, the remote screen transmitting system stores, in a frame buffer, a remote screen obtained by capturing an execution screen of an application executed on the virtualization server 410. The remote screen transmitting system may adjust a frame processing rate for compression of the remote screen based on an amount of power consumed by the thin client terminal in the collected power data in operation 412, and transmit the remote screen to the thin client terminal 420 in operation 413.

The thin client terminal 420 may receive the remote screen from the remote screen transmitting system and execute (display) the remote screen, and transmit event information to the virtualization server 410 in operation 421.

The thin client terminal 420 may transmit, on the predetermined cycle, the power data to the virtualization server 410 by analyzing the amount of power consumed by the thin client terminal and an amount of power remaining in the thin client terminal in real time in operation 422.

Because an amount of power consumed by a central processing unit (CPU) included in the thin client terminal 420 is proportional to a square of a voltage or a clock frequency, a recently developed embedded processor may provide a dynamic frequency scaling function and a dynamic voltage scaling function.

An operation system (OS) may perform power management by switching a terminal to an idle mode or a sleep mode based on a system load using the dynamic frequency scaling function and the dynamic voltage scaling function. Recently, terminal power management has been performed through a predetermined application that provides a power management framework.

In a process in which the virtualization server 410 is initially connected to the thin client terminal 420, the remote screen transmitting system may obtain information on a compression scheme preferred by the thin client terminal 420 and determine a remote screen transmitting scheme based on the obtained information.

The thin client terminal 420 may transmit the amount of power consumed by the thin client terminal 420 to the virtualization server 410 through a remote frame buffer (RFB) protocol to directly request a change of the remote screen transmitting scheme or to dynamically determine the remote screen transmitting scheme based on the amount of power consumed transmitted to the virtualization server 410 in the remote screen transmitting system.

The remote screen transmitting scheme may be classified as a RAW pixel data transmitting scheme for transmitting data associated with a predetermined area in the frame buffer and an object based data transmitting scheme for transmitting a graphic command to the thin client terminal 420 in the virtualization server 410. When the RFB protocol is used in the thin client terminal 420, the remote screen transmitting system may transmit the remote screen to the thin client terminal 420 based on the RAW pixel data transmitting scheme.

When the thin client terminal 420 transmits the remote screen based on the RAW pixel data transmitting scheme through the RFB protocol, the remote screen transmitting system may transmit the remote screen to the thin client terminal 420 using a self compression algorithm in order to compensate for a problem of network transmissions increasing due to a major change in the frame buffer.

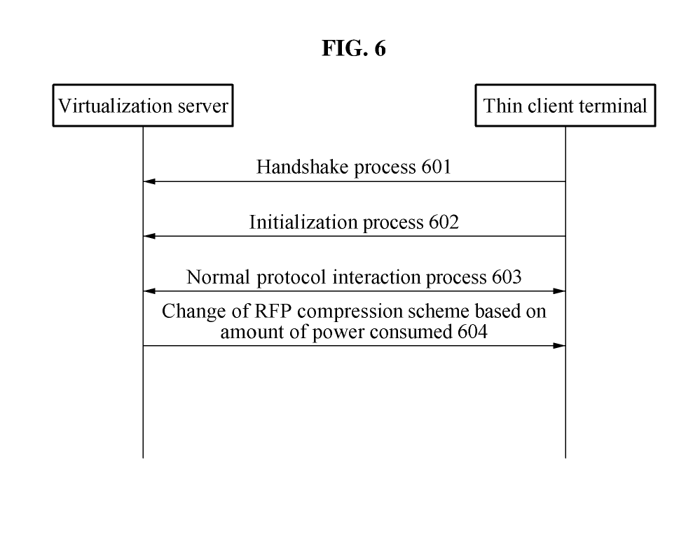

FIG. 5 is a flowchart illustrating a remote screen transmitting method according to an example embodiment.

A remote screen transmitting method may be performed by the remote screen transmitting system 200.

Referring to FIG. 5, in operation 510, the remote screen transmitting system 200 collects, on a predetermined cycle, power data from a thin client terminal connected to a virtualization server through a network.

For example, referring to FIG. 8, the remote screen transmitting system 200 may collect the power data including the amount of power consumption 809 and the amount of remaining power 810 from the update request message 800 when the update request message 800 is transmitted to the virtualization server by the thin client terminal.

In operation 520, the remote screen transmitting system 200 determines a remote screen transmitting scheme based on the collected power data.

The remote screen transmitting system 200 may determine the remote screen transmitting scheme including at least one of a frame processing rate during compressing, a compression scheme, or whether a first remote screen is compressed when transmitting the first remote screen to the thin client terminal based on the amount of power consumed by the thin client terminal and the amount of power remaining in the thin client terminal, in the collected power data.

For example, the remote screen transmitting system 200 may decide not use the compression scheme when the first remote screen is transmitted to the thin client terminal in response to a determination that the remote screen transmitting scheme is a RAW data transmitting scheme, such that an amount of use of a central processing unit (CPU) in the thin client terminal is decreased and the amount of power consumed is decreased, when it is determined that a power required for operating the thin client terminal is less than a minimum power, for example, a reference value, or the amount of power currently consumed by the thin client terminal is greater than or equal to a first threshold even though the amount of power remaining in the thin client terminal is greater than or equal to the reference value.

When it is determined that the thin client terminal is currently consuming a low amount of power based on the amount of power consumed by the thin client terminal, the remote screen transmitting system 200 may change a compression scheme to a high efficiency compression scheme, for example, the JPEG encoding scheme, in order to enhance a quality of user experience. When it is determined that the thin client terminal is currently consuming a medium amount of power, the remote screen transmitting system 200 may selectively determine the compression scheme, for example, a Zlib run-length encoding (ZRLE) scheme, a Hextile encoding scheme, and a CopyRect encoding scheme, to be provided by a remote frame buffer (RFB) protocol in order to effectively control the amount of power consumed by the thin client terminal in lieu of decreasing the quality of user experience.

In operation 530, the remote screen transmitting system 200 transmits the first remote screen associated with the application executed on the virtualization server to the thin client terminal based on the remote screen transmitting scheme.

For example, the remote screen transmitting system 200 may compare the first remote screen obtained by capturing the execution screen of the application executed on the virtualization server to a second remote screen corresponding to a previous capture image obtained from a frame buffer, and transmit an updated area to the thin client terminal through a remote screen transmission protocol, thereby minimizing an amount of traffic used to transmit the updated area to the thin client terminal.

Accordingly, the thin client terminal may display the first remote screen corresponding to a current version by rendering the received updated area and the second remote screen corresponding to the previous version.

When the amount of change in the first remote screen is great, the remote screen transmitting system 200 may encode the first remote screen in real time and transmit the first remote screen to the thin client terminal.

Also, referring to FIG. 8, the remote screen transmitting system 200 may transmit the update message 820 including the buffer value for the frame buffer 240 in which the date area is maintained in response to the update request message 800 from the thin client terminal, and allow the thin client terminal to render the updated area by searching for the updated area in the frame buffer 240 identified by the thin client terminal based on the buffer value. Thus, the identical first remote screen in the virtualization server may be displayed in the thin client terminal through rendering of a graphic image.

For example, the remote screen transmitting system 200 may actively switch the virtualization mode to a standby mode to reduce a standby power of the virtualization server when the thin client terminal is in the standby mode or an update request message is not received from the thin client terminal for a predetermined length of time.

In detail, the remote screen transmitting system 200 may allow the virtualization server to stop using resource, for example, a graphic processing unit (GPU) resource, a memory resource, and network resource, of a process corresponding to the thin client terminal in the virtualization server while the thin client terminal is in the standby mode, such that the virtualization server is switched to the standby mode.

FIG. 6 is a diagram illustrating a method of controlling an amount of power consumed by a thin client terminal using a remote frame buffer (RFB) protocol in a remote screen transmitting system according to an example embodiment.

Referring to FIG. 6, a remote screen transmitting system may be included in a virtualization server.

A thin client terminal using an RFB protocol performs a handshake process 601 for making a network connection to the virtualization server and an initialization process 602 to process an authentication request or to exchange information on a pixel format and a name of a desktop.

Subsequently, the thin client terminal performs a normal protocol interaction process 603.

The thin client terminal may transmit a message indicating a desired encoding method and the pixel format to the virtualization server in order to obtain a remote screen executed on the virtualization server, and the remote screen transmitting system may transmit the remote screen to the thin client terminal based on the message.

The thin client terminal may transmit an update request message to the virtualization server when an event in which the remote screen is changed occurs through an input device, for example, a mouse and a keyboard. Thus, the remote screen transmitting system may transmit, to the thin client terminal, an update message indicating a buffer value for a frame buffer in which an updated area in the remote screen is maintained.

The remote screen transmitting system may check, in real time, an amount of power consumed by the thin client terminal to effectively use the amount of power consumed by the thin client terminal. When the thin client terminal consumes a large amount of power or an amount of power remaining in the thin client terminal is relatively small, the remote screen transmitting system may perform a change 604, such that a current compression scheme based on the RFB protocol is changed to a compression scheme that consumes a relatively small amount of power.

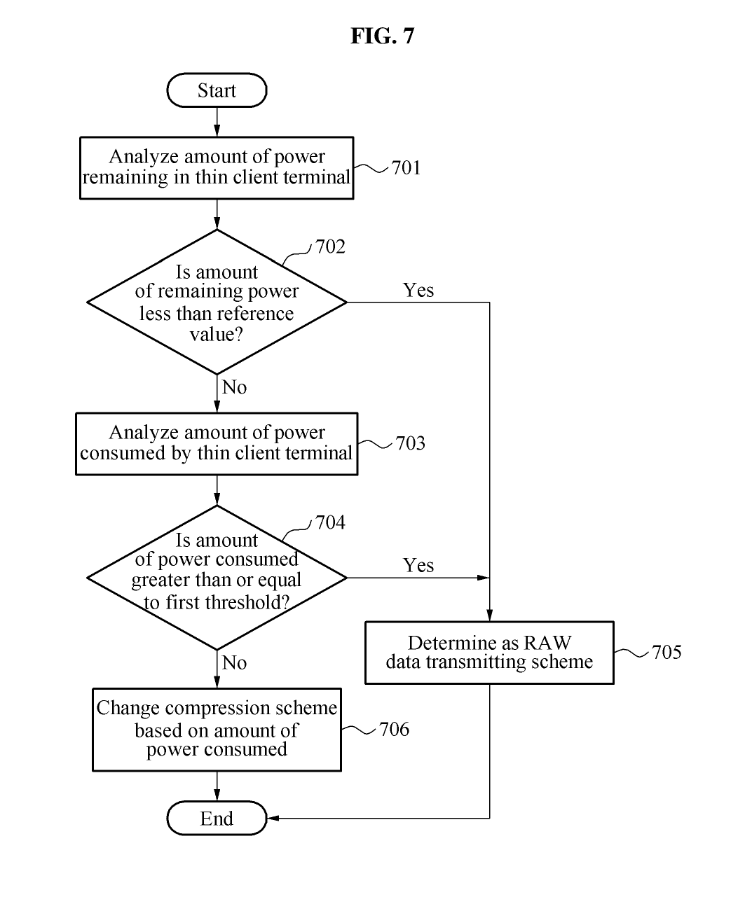

FIG. 7 is a flowchart illustrating a process of changing a compression scheme to a remote screen transmitting scheme based on power data collected from a thin client terminal in a remote screen transmitting system according to an example embodiment.

Referring to FIG. 7, in operation 701, a remote screen transmitting system analyzes an amount of power remaining in a thin client terminal.

The thin client terminal may obtain, on a predetermined cycle, power data including the current amount of power consumed and an available amount of power remaining in the thin client terminal, and transmit the power data to a virtualization server. The remote screen transmitting system may collect the power data to analyze the amount of power remaining in the thin client terminal. The thin client terminal may learn the available amount of power remaining in the thin client terminal using Upower when the thin client terminal is a Linux based terminal.

In operation 702, the remote screen transmitting system determines whether the amount of power remaining in the thin client terminal is less than a reference value.

In operation 703, based on a result of the determination that the amount of remaining power is not less than the threshold, the remote screen transmitting system analyzes the amount of power consumed by the thin client terminal.

In operation 704, the remote screen transmitting system determines whether the amount of power consumed is greater than or equal to a first threshold.

In operation 706, based on a result of the determination that the amount of power consumed is not greater than or equal to the first threshold, the remote screen transmitting system changes a compression scheme based on the amount of power consumed.

The remote screen transmitting system may determine, again, whether the amount of power consumed is less than a second threshold less than the first threshold when the amount of power currently consumed by the thin client terminal is less than the first threshold and the amount of power consumed indicates that the thin client terminal consumes a normal amount of power.

Based on a result of the redetermination that the amount of power consumed is less than the second threshold, the remote screen transmitting system may determine that the thin client terminal currently consumes a low amount of power and then determine a high efficiency compression scheme, for example, a joint photographic coding experts group (JPEG) encoding scheme, to be provided in order to enhance a quality of user experience.

Based on a result of the redetermination that the amount of power consumed is less than the first threshold and greater than or equal to the second threshold, the remote screen transmitting system may determine that the thin client terminal currently consumes a medium amount of power and then selectively determine the compression scheme, for example, a Zlib run-length encoding (ZRLE) scheme, a Hextile encoding scheme, and a CopyRect encoding scheme, to be provided by a remote frame buffer (RFB) protocol.

Based on the result of the determination that the amount of remaining power is less than the reference value in operation 702 or the result of the determination that the amount of power consumed is greater than or equal to the first threshold in operation 704, the remote screen transmitting system may determine the compression scheme to be a RAW data transmitting scheme.

In operation 705, the remote screen transmitting system may determine a remote screen transmitting scheme to be a RAW data transmitting scheme not using a compression scheme when a remote screen is transmitted to the thin client terminal, such that an amount of use of a central processing unit (CPU) in the thin client terminal is decreased and the amount of power consumed is decreased, when it is determined that an amount of power required for operating the thin client terminal is less than a minimum amount of power, for example, a reference value, or the amount of power currently consumed by the thin client terminal is greater than or equal to a first threshold even though the amount of remaining power is greater than or equal to the reference value.

Thus, the remote screen transmitting system may effectively control the amount of power consumed by the thin client terminal by dynamically determining the remote screen transmitting scheme based on the amount of power consumed by the thin client terminal in lieu of decreasing a quality of user experience.

FIG. 8 is a diagram illustrating an update request message received from a thin client terminal and an update message to be transmitted to the thin client terminal in response to the update request message according to an example embodiment.

FIG. 8 illustrates the update request message 800 and the update message 820.

Referring to FIG. 8, the update request message 800 includes a message type field 801 and a message specific data field 802, and the message specific data field 802 includes a plurality of fields 803 including a field of a number of bytes, a type field, and a value field.

The value field may include, for each type, the incremental value 804, an x-position 805, a y-position 806, a width 807, a height 808, the amount of power consumption 809, and the amount of remaining power 810.

The update request message 802 also includes a message type field and a message specific data field. The message specific data field includes n rectangle fields 821 and a header including a field of a number of bytes and a value field. Each of the rectangle fields 821 includes pixel data 822.

A remote screen transmitting system may verify the amount of power consumption 809 and the amount of remaining power 810 from the update request message 800 when the update request message 800 is received from the thin client terminal, with respect to a remote screen obtained by capturing an execution screen of an application executed on a virtualization server.

The remote screen transmitting system may determine a remote screen transmitting scheme for transmitting an updated screen for the remote screen based on the verified amount of power consumption 809 and the amount of remaining power 810.

The remote screen transmitting system may transmit the updated screen for the remote screen to the thin client terminal based on the remote screen transmitting scheme in response to the update request message 800.

The remote screen transmitting system may transmit the update message 820 including the updated screen to the thin client terminal, and transmit the update message 820 including a buffer value for a frame buffer in which the updated screen is maintained and allow the thin client terminal to render the updated screen by searching for the updated screen in the frame buffer identified by the thin client terminal based on the buffer value.

The remote screen transmitting system may transmit, as the update screen, a remote screen obtained by capturing an entire updated execution screen when an amount of change due to an update is great. Conversely, the remote screen transmitting system may transmit, as the update screen, a portion of an updated area in the remote screen when the amount of change due to the update is small.

In an example, the remote screen transmitting system may request a value of an updated frame buffer by transmitting the update request message 800 from the thin client terminal to the virtualization server through a FrameBufferRequest command.

The remote screen transmitting system may transmit the update message 820 including the value of the updated frame buffer to the thin client terminal when a comparison between a value of a previously transmitted frame buffer (or a second remote screen) and a value of a current frame buffer (or a first remote screen) indicates that there is a change.

Thus, the identical remote screen in the virtualization server may be displayed in the thin client terminal through rendering of a graphic image.

The thin client terminal may repeatedly transmit the update request message 800 to the virtualization server when the update message 820 is not received from the virtualization server for a predetermined length of time, for example, seconds or minutes. Thus, the thin client terminal may repeatedly perform an unnecessary graphic processing process or use a large amount of network bandwidth, thereby increasing an amount of power consumed by the thin client terminal.

Thus, the remote screen transmitting system may limit transmission of the update request message 800 in the thin client terminal to decrease the amount of power consumed by the thin client terminal.

As illustrated in FIG. 8, the remote screen transmitting system may be allowed to generate the update request message 800 including the amount of power consumption 809 and the amount of remaining power 810 when the update request message 800 is transmitted in the thin client terminal.

The remote screen transmitting system may assign, using a scheduler, a high priority to a thin client terminal of which the amount of remaining power 810 is relatively low in the update request message 800 among a plurality of thin client terminals that transmit the update request message 800 to the virtualization server, and transmit the update message 820 in response to the update request message 800 from the thin client terminal assigned high priority.

Also, when the update request message 800 is repeatedly received from the same thin client terminal, the remote screen transmitting system may transmit, to the thin client terminal, the update message 820 for the update request message 800 in which the amount of remaining power 810 is lowest, in lieu of transmitting all update messages, for example, the update message 820, in response to each update request message 800. Thus, the remote screen transmitting system may selectively respond to a most recent update request from the thin client terminal, thereby effectively decreasing the amount of power consumed by the thin client terminal.

In an example, the remote screen transmitting system may determine the incremental value 804 in the update request message 800 when the update request message 800 is repeatedly received by the thin client terminal, with respect to the frame buffer in which an identical remote screen is maintained. When the incremental value 804 does not correspond to “0”, that is, when the thin client terminal has a previously received frame buffer value (the second remote screen corresponding to the previous version), the remote screen transmitting system may transmit the update message 820 including the pixel data 822, as RAW data, for the rectangle field that constitutes the updated area in the first remote screen to the thin client terminal, in lieu of transmitting, to the thin client terminal, a total value of the frame buffer in which the first remote screen corresponding to the current version is maintained.

When the incremental value 804 corresponds to “0”, that is, when the thin client terminal does not have the previously received frame buffer value (the second remote screen corresponding to the previous version), the remote screen transmitting system may generate the update message 820 to be transmitted to the thin client terminal by encoding the total value of the frame buffer in which the first remotes screen corresponding to the current version is maintained.

According to an aspect of the present invention, it is possible to dynamically determine a remote screen transmitting scheme, for example, a compression scheme and a frame rate processing rate, based on power data, for example, an amount of power consumed and an amount of remaining power, in a thin client terminal and transmit a remote screen to the thin client terminal, thereby effectively controlling an amount of power consumed by the thin client terminal in lieu of decreasing the quality of user experience.

According to another aspect of the present invention, it is possible to decrease an amount of power consumed by a thin client terminal, for example, a smartphone, a tablet personal computer (PC), and a home set-top box, that limitedly uses power to increase an amount of time a battery may be used by dynamically determining a remote screen transmitting scheme during transmission of a remote screen to the thin client terminal when an amount of power remaining in the thin client terminal is less than a reference value or the amount power consumed by the thin client terminal is greater than or equal to a threshold.

According to still another aspect of the present invention, it is possible to execute (display) a remote screen as a result of an application executed on a virtualization server on a cloud in a thin client terminal of low specification while maintaining a quality of user experience based on power consumption.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A remote screen transmitting method comprising:
collecting, on a predetermined cycle, power data from a thin client terminal connected to a virtualization server through a network;
determining a remote screen transmitting scheme based on the collected power data; and
transmitting, to the thin client terminal, a first remote screen associated with an application executed on the virtualization server based on the remote screen transmitting scheme.

2. The method of claim 1, wherein the determining of the remote screen transmitting scheme comprises determining the remote screen transmitting scheme including at least one of a frame processing rate during compressing, a compression scheme, or whether the first remote screen is compressed when transmitting the first remote screen to the thin client terminal based on an amount of power consumed by the thin client terminal and an amount of power remaining in the thin client terminal, in the collected power data.

3. The method of claim 1, wherein the determining of the remote screen transmitting scheme comprises determining the remote screen transmitting scheme to be a RAW data transmitting scheme not using a compression scheme when an amount of power remaining in the thin client terminal in the power data is less than a reference value or an amount of power consumed by the thin client terminal in the power data is greater than or equal to a set first threshold.

4. The method of claim 1, wherein the determining of the remote screen transmitting scheme comprises changing, based on an amount of power consumed, a compression scheme when the first remote screen is transmitted to the thin client terminal, when an amount of power remaining in the thin client terminal in the power data is greater than or equal to a reference value and the amount of power consumed in the power data is less than a set first threshold.

5. The method of claim 4, wherein the changing of the compression scheme comprises:
changing the compression scheme to a joint photographic coding experts group (JPEG) encoding scheme when the amount of power consumed is less than a second threshold less than the first threshold; and
selectively changing the compression scheme to at least one of a Zlib run-length encoding (ZRLE) scheme, a Hextile encoding scheme, a CopyRect encoding scheme, provided by a remote frame buffer (RFB) protocol when the amount of power consumed is less than the first threshold and greater than or equal to the second threshold.

6. The method of claim 1, further comprising:
adjusting a frame processing rate for compressing the first remote screen based on a pattern of an amount of power consumed by the thin client terminal in the power data and transmitting the first remote screen to the thin client terminal based on the adjusted frame processing rate when the first remote screen includes an image or a video stream.

7. The method of claim 1, further comprising:
transmitting the first remote screen to the thin client terminal by determining a remote screen transmitting scheme requested by the thin client terminal when the first remote screen is transmitted to the thin client terminal using an RFB protocol.

8. The method of claim 1, further comprising:
when a point during a selected screen update cycle arrives,
obtaining a second remote screen from a frame buffer assigned to a previous version differing from a current version of the first remote screen;
extracting an update area from the first remote screen based on the second remote screen; and
transmitting the update area to the thin client terminal based on the remote screen transmitting scheme.

9. The method of claim 8, further comprising:
storing the update area and the first remote screen in a frame buffer assigned to the current version; and
when the second remote screen is maintained in the thin client terminal,
transmitting a buffer value to the thin client terminal and allowing the thin client terminal to use the update area during rendering of the first remote screen by searching for the update area in a frame buffer identified by the thin client terminal based on the buffer value.

10. The method of claim 9, further comprising:
when the second remote screen is not maintained in the thin client terminal,
transmitting, to the thin client terminal, a buffer value for a frame buffer that stores a remote screen obtained by capturing an execution screen of the application executed on the virtualization server and allowing the thin client terminal to use the remote screen during rendering of the first remote screen by searching for the remote screen in the frame buffer identified by the thin client terminal based on the buffer value.

11. The method of claim 9, further comprising:
when a plurality of update request messages associated with the frame buffer are received from the thin client terminal,
assigning a buffer value transmission priority to each of the update request messages based on an amount of remaining power in each of the update request messages.

12. The method of claim 1, further comprising:
switching the virtualization server to a standby mode when the thin client terminal is in standby mode or an update request message is not received from the thin client terminal for a predetermined length of time.

13. A remote screen transmitting system, the system comprising:
a collector configured to collect, on a predetermined cycle, power data from a thin client terminal connected to a virtualization server through a network;
a determiner configured to determine a remote screen transmitting scheme based on the collected power data; and
a transmitter configured to transmit, to the thin client terminal, a first remote screen associated with an application executed on the virtualization server based on the remote screen transmitting scheme.

14. The system of claim 13, wherein the determiner is configured to determine the remote screen transmitting scheme including at least one of a frame processing rate during compressing, a compression scheme, or whether the first remote screen is compressed when transmitting the first remote screen to the thin client terminal based on an amount of power consumed by the thin client terminal and an amount of power remaining in the thin client terminal, in the collected power data.

15. The system of claim 13, wherein the determiner is configured to determine the remote screen transmitting scheme as a RAW data transmitting scheme not using a compression scheme when an amount of power remaining in the thin client terminal in the power data is less than a reference value or an amount of power consumed by the thin client terminal in the power data is greater than or equal to a set first threshold.

16. The system of claim 13, wherein the determiner is configured to change, based on an amount of power consumed, a compression scheme when the first remote screen is transmitted to the thin client terminal, when an amount of power remaining in the thin client terminal in the power data is greater than or equal to a reference value and the amount of power consumed in the power data is less than a set first threshold.

17. The system of claim 13, wherein, when a point during a selected screen update cycle arrives, the transmitter is configured to obtain a second remote screen frame buffer assigned to a previous version differing from a current version of the first remote screen, extract an update area from the first remote screen based on the second remote screen, and transmit the update area to the thin client terminal based on the remote screen transmitting scheme.

18. The system of claim 17, wherein the transmitter is configured to store the update area and the first remote screen in a frame buffer assigned to the current version, and use a buffer value during rendering of the first remote screen by transmitting the buffer value to the thin client terminal and searching for the update area in a frame buffer identified by the thin client terminal based on the buffer value when the second remote screen is maintained in the thin client terminal.

19. The system of claim 17, wherein, when the second remote screen is not maintained in the thin client terminal, the transmitter is configured to use a buffer value during rendering of the first remote screen by transmitting, to the thin client terminal, the buffer value for a frame buffer that stores a remote screen obtained by capturing an execution screen of the application executed on the virtualization server and search for the remote screen in the frame buffer identified by the thin client terminal based on the buffer value.

20. The system of claim 13, wherein the transmitter is configured to switch the virtualization server to a standby mode when the thin client terminal is in standby mode or an update request message is not received from the thin client terminal for a predetermined length of time.
